(19) United States
(12) Patent Application Publication
(10) Pub. No.: US 2007/0163084 A1
(43) Pub. Date: Jul. 19, 2007

(54) TOOL

(76) Inventor: Mou-Tang Liou, Ta Li City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/306,993

(22) Filed: Jan. 18, 2006

(51) Int. Cl. E05B 1/00

(52) U.S. Cl. 16/436

(57) ABSTRACT

A tool includes a handle, a controller and a bit. The handle includes a socket defining an axial non-circular space and a radial space in communication with the axial space. The controller includes a space defined therein and a ridge formed on the wall of the space thereof. The controller is movable in the radial space of socket between a locking position and a releasing position. The bit includes a working tip and a shank defining at least one recess for receiving the ridge when the shank is inserted into the space of the controller through the axial space of the socket, thus locking the bit to the handle.

### BACKGROUND OF INVENTION

1. Field of Invention

The present invention relates to a tool and, more particularly, to a tool including a chuckle for engagement with a bit.

2. Related Prior Art

Disclosed in Taiwanese Patent Publication no. 554796 is a tool including a chuckle 20 for engagement with a bit 40. The chuckle 20 includes a socket 21, a ball 24 and two rings 26 and 28. The rings 26 and 28 can be rotated on the socket 21 so as to move the ball 24 longitudinally and peripherally on the socket 21 so that the bit 40 can be engaged with and disengaged from the chuckle 20. The tool includes a lot of components and forms a complicated structure. Moreover, a user has to operate the chuckle 20 with two hands.

The present invention is therefore intended to obviate or at least alleviate the problems encountered in prior art.

### SUMMARY OF INVENTION

According to the present invention, a tool includes a handle, a controller and a bit. The handle includes a socket defining an axial non-circular space and a radial space in communication with the axial space. The controller includes a space defined therein and a ridge formed on the wall of the space thereof. The controller is movable in the radial space of socket between a locking position and a releasing position. The bit includes a working tip and a shank defining at least one recess for receiving the ridge when the shank is inserted into the space of the controller through the axial space of the socket, thus locking the bit to the handle.

An advantage of the tool according to the present invention is its small number of elements and simple structure.

Another advantage of the tool according to the present invention is that a user can easily operate the tool with only one hand.

Other advantages and features of the present invention will become apparent from the following description referring to the drawings.

### BRIEF DESCRIPTION OF DRAWINGS

The present invention will be described through detailed illustration of three embodiments referring to the drawings.

FIG. 1 is a perspective view of a tool according to the first embodiment of the present invention.

FIG. 2 is an exploded view of the tool shown in FIG. 1.

FIG. 3 is a cross-sectional view of the tool shown in FIG. 1.

FIG. 4 is a cross-sectional view of the tool in another position than shown in FIG. 3.

FIG. 5 is a cross-sectional view of the tool in another position than shown in FIG. 4.

FIG. 6 is a cutaway view of a tool according to the second embodiment of the present invention.

FIG. 7 is a cutaway view of the tool in another position than shown in FIG. 6.

FIG. 8 is a cross-sectional view of a tool according to the third embodiment of the present invention.

FIG. 9 is a cross-sectional view of the tool in another position than shown in FIG. 8.

### DETAILED DESCRIPTION OF PREFERRED EMBODIMENT

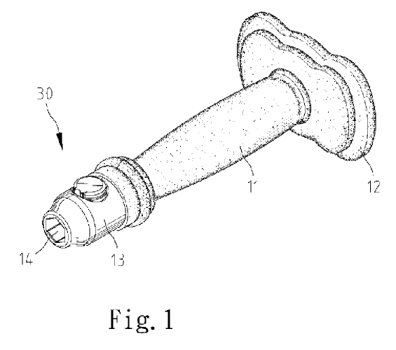

Referring to FIG. 1, there is shown a tool 10 according to a first embodiment of the present invention. The tool 10 includes a handle 11, an anvil 12 formed at an end of the handle 11 and a socket 13 formed at an opposite end of the handle 11. The anvil 12 is for encountering a hammer. The anvil 12 includes a large area for protecting a user's hand from the hammer. A controller 30 is installed on the socket 13.

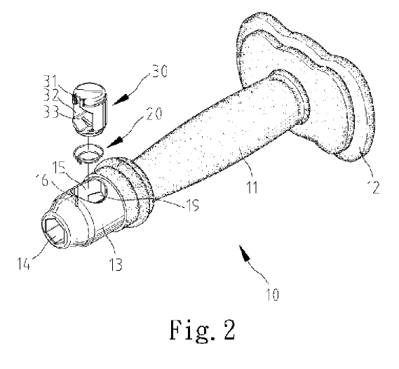

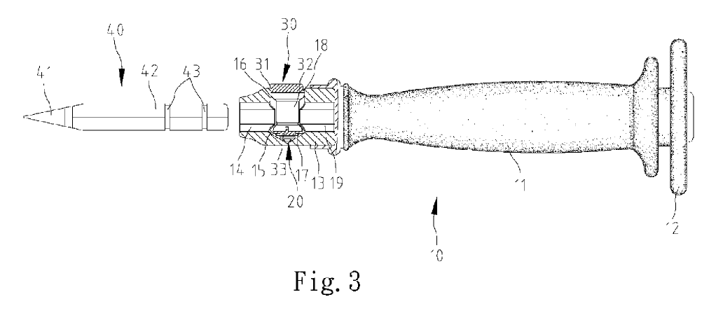

Referring to FIGS. 2 and 3, the socket 13 defines a first axial non-circular space 14, a second axial non-circular space 19, a radial space 15 for communicating the first axial non-circular space 14 with the second axial non-circular space 19 and a radial taper cavity 17 in communication with the radial space 15. Preferably, the non-circular spaces 14 and 19 are hexangular spaces. The radial taper cavity 17 is made by means of a tip of a drill. In another embodiment, a radial flat-bedded cavity may be made instead of the radial taper cavity 17 if milling is adopted instead of drilling. A ridge 16 is formed on the wall of the radial space 15.

An elastic element 20 is located in the radial taper cavity 17. The elastic element 20 includes a configuration corresponding to the radial taper cavity 17.

The controller 30 includes a first end located in the radial space 15 of the socket 13 and a second end exposed from the radial space 15 of the socket 13. The second end of the controller 30 is located against the elastic element 20. A user can push the controller 30 by the second end. The controller 30 defines, near the second end, a recess 31 for receiving the ridge 16 so that the controller 30 cannot rotate in the radial space 15 of the socket 13. In another embodiment, the positions of the recess 31 and the ridge 16 can be exchanged. In still another embodiment, the recess 31 and the ridge 16 can be omitted if the controller 30 and the radial space 15 are non-circular. The controller 30 includes, near the second end, a shoulder restrained by means of a restraint 18 formed on the socket 13. The restraint 18 is made by means of hammering a portion of the socket 13 near the radial space 15. The controller 30 defines a space 32 corresponding to the axial non-circular spaces 14 and 19. A ridge 33 is formed on the floor of the space 32.

The bit 40 includes a working tip 41 and a shank 42. A plurality of annular grooves 43 is defined in the shank 42 of the bit 40. The working tip 41 is in the form of a chisel.

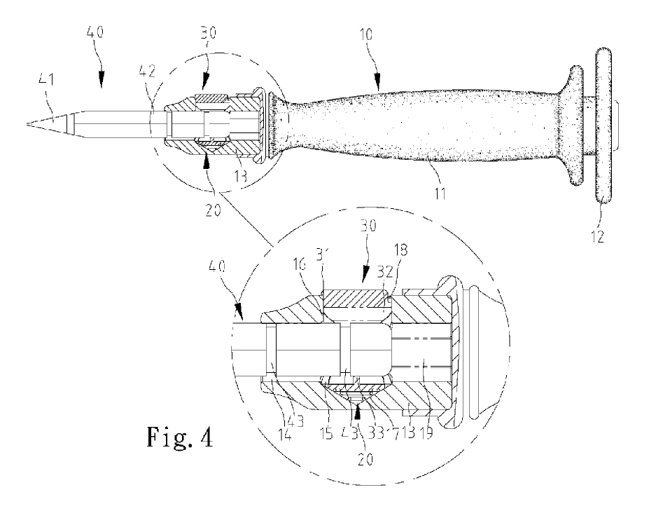

Referring to FIG. 4, the shank 42 of the bit 40 is inserted into the space 32 of the controller 30 through the first axial non-circular space 14 of the socket 13. The shank 42 of the bit 40 pushes down the ridge 33, thus lowering the controller 30 and compressing the elastic element 20.

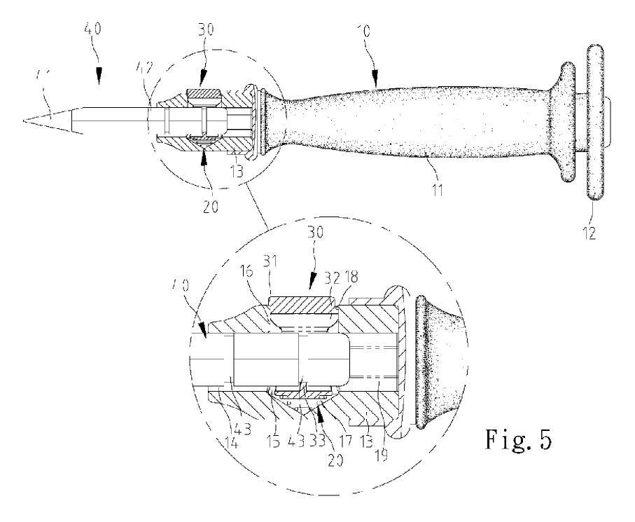

Referring to FIG. 5, one of the annular grooves 43 finally reaches the ridge 33. The elastic element 20 lifts the controller 30 so that the ridge 33 enters the annular groove 43. Therefore, the bit 40 is locked to the socket 13.

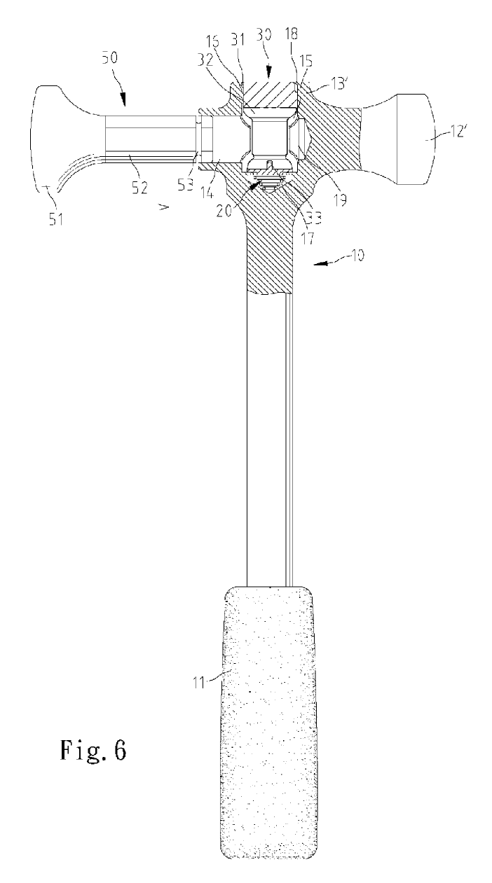

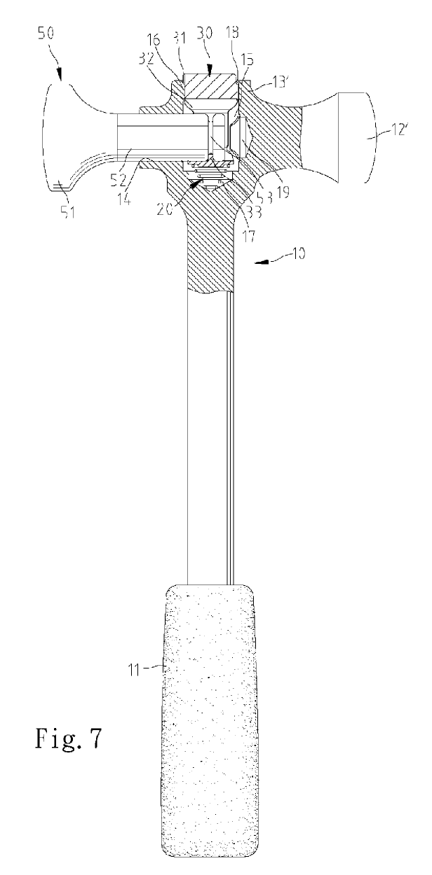

Referring to FIGS. 6 and 7, there is shown a tool according to a second embodiment of the present invention. The second embodiment is like the first embodiment except several things. Firstly, the axis of the socket 13 is perpendicular to that of the handle 11. Secondly, a hammer 12′ is used instead of the anvil 12. Thirdly, a bit 50 is used instead of the bit 40. The bit 50 includes a working tip 51 in the form of a hammer and a shank 52. An annular groove 53 is defined in the shank 52 of the bit 50.

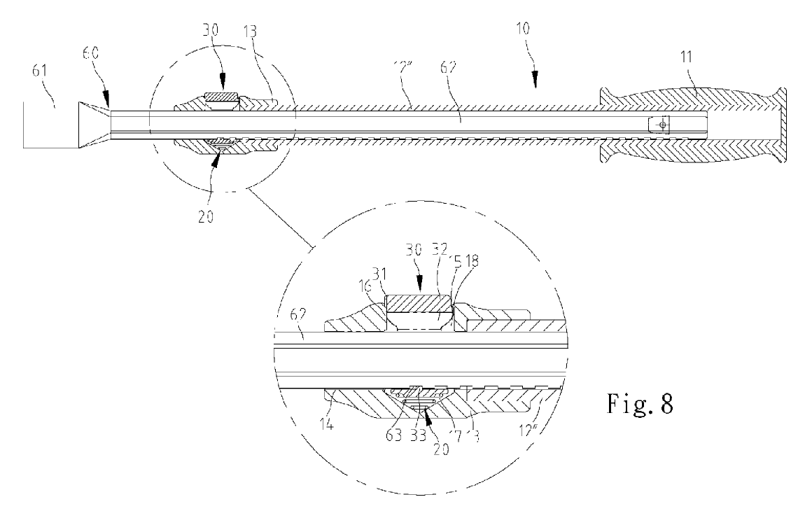

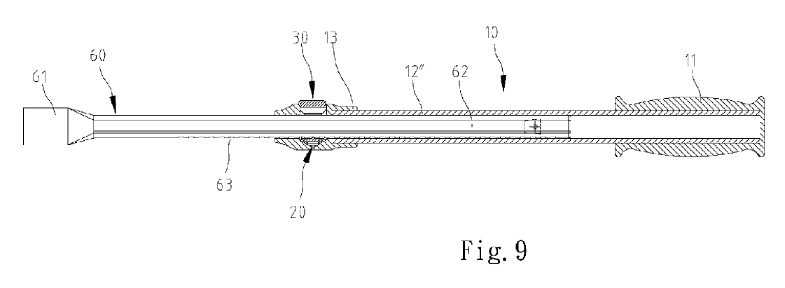

Referring to FIGS. 8 and 9, there is shown a tool according to a third embodiment of the present invention. The third embodiment is like the first embodiment except several things. Firstly, the socket 13 is made separate from the handle 11. Secondly, an extension pipe 12″ is installed between the handle 11 and the socket 13. Thirdly, a bit 60 is used instead of the bit 40. The bit 60 includes a working tip 61 in the form of a screwdriver and an elongated shank 62 for insertion into the extension pipe 12″. A plurality of recesses 63 is defined in the elongated shank 62. One of the recesses 63 receives the ridge 33 so as to position the bit 60.

The tool according to the present invention exhibits some advantages. Firstly, it includes only a few elements and forms a simple structure. Secondly, a user can easily operate the tool with only one hand.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A tool comprising:
a handle comprising, at an end, a socket defining an axial non-circular space and a radial space in communication with the axial space;
a controller comprising a space defined therein and a ridge formed on the wall of the space thereof, wherein the controller is movable in the radial space of socket between a locking position and a releasing position; and
a bit comprising a working tip and a shank defining at least one recess for receiving the ridge when the shank is inserted into the space of the controller through the axial space of the socket, thus locking the bit to the handle.

2. The tool according to claim 1 comprising an elastic element located in the radial space of the socket for pushing the controller to the locking position.

3. The tool according to claim 2 wherein the elastic element is a spring.

4. The tool according to claim 3 wherein the spring is a conical spring.

5. The tool according to claim 4 wherein the socket defines a radial taper cavity in communication with the radial space thereof so as to contain the conical spring.

6. The tool according to claim 1 wherein the socket comprises a ridge on the wall of the radial space thereof, wherein the controller defines a recess for receiving the ridge of the socket so as to prevent the rotation of the controller in the radial space of the socket.

7. The tool according to claim 1 wherein the socket comprises a restraint formed thereon for restraining the controller in the radial space thereof.

8. The tool according to claim 7 wherein the restraint is formed by means of hammering a portion of the socket near the radial space of the socket.

9. The tool according to claim 1 wherein the non-circular space of the socket is a hexagonal space.

10. The tool according to claim 1 wherein the axis of the socket is parallel to that of the handle.

11. The tool according to claim 10 wherein the working tip of the tool is in the form of a chisel.

12. The tool according to claim 11 wherein the handle comprises an anvil at an opposite end for encountering a hammer.

13. The tool according to claim 1 wherein the axis of the socket is perpendicular to that of the handle.

14. The tool according to claim 13 wherein the working tip of the bit is in the form of a hammer.

15. The tool according to claim 14 wherein the handle comprises a hammer at an opposite end.

16. A tool comprising:
a handle;
a socket defining an axial non-circular space and a radial space in communication with the axial space;
an extension pipe for connecting the socket to the handle;
a controller comprising a space defined therein and a ridge formed on the wall of the space thereof, wherein the controller is movable in the radial space of socket between a locking position and a releasing position; and
a bit comprising a working tip and an elongated shank defining at least one recess for receiving the ridge when the elongated shank of the bit is inserted into the space of the controller through the axial space of the socket, thus locking the bit to the handle.

17. The tool according to claim 16 comprising an elastic element located in the radial space of the socket for pushing the controller to the locking position.

18. The tool according to claim 16 wherein the socket comprises a ridge on the wall of the radial space thereof, wherein the controller defines a recess for receiving the ridge of the socket so as to prevent the rotation of the controller in the radial space of the socket.

19. The tool according to claim 16 wherein the socket comprises a restraint formed thereon for restraining the controller in the radial space thereof.
